(19) United States
(12) Patent Application Publication
(10) Pub. No.: US 2014/0174823 A1
(43) Pub. Date: Jun. 26, 2014

(54) METHOD FOR SLEEVE RETAINING A SOLDER MATERIAL ONTO A TERMINAL UNIT

(71) Applicant: CHIEF LAND ELECTRONICS CO., LTD., New Taipei City (TW)

(72) Inventors: CHUNG-NAN PAO, NEW TAIPEI CITY (TW); SUN WU CHOU, KEELUNG CITY (TW)

(73) Assignee: CHIEF LAND ELECTRONIC CO., LTD., NEW TAIPEI CITY (TW)

(21) Appl. No.: 13/724,171

(22) Filed: Dec. 21, 2012

(51) Int. Cl. H01R 4/20; H01R 43/02

(52) U.S. Cl. CPC H01R 4/20; H01R 43/0235
USPC 174/84 C; 228/173.2

(57) ABSTRACT

The present disclosure relates to a method of sleeve retaining a solder material onto a terminal unit comprises of steps. In order to achieve the steps, a structure is also disclosed which comprises: a terminal unit and a solder material wherein the terminal unit possess a fixing portion while the solder material forms a sleeve which corresponds to the terminal unit, therefore enabling the sleeve retaining of the solder material. By means of sleevingly retain as described above, the assembly of the terminal unit and the solder material can be further stabilized.

### BACKGROUND OF THE INVENTION

1. Field of the Invention

The instant disclosure relates to a method for sleeve retaining a solder material; in particular, to an electric connector terminal unit

2. Description of Related Art

As technology advances, electronic components are becoming increasingly miniaturized. Consequently, soldering precision of miniaturized electronic components is becoming a greater challenge for surface mount technology (SMT).

To retain soldering materials onto a terminal unit, one of the conventional approaches includes dipping the terminal unit into a sphere-shaped soldering material. However, with the conventional approach, soldering material is highly susceptible to falling off from the terminal unit which leads to poor welding quality/reliability. Another approach disposes the soldering material onto the side surface of the terminal unit. However, since the positioning of the soldering materials is susceptible to shift from the terminal unit, welding accuracy is hindered in the traditional method unless a welder resets and fine-tunes the positioning of the soldering materials. Based on today's miniaturization trend, soldering accuracy is quite critical to production especially when electronic components are in close proximity, a minuscule deviation can cause tremendous repercussions.

To address the above issues, the inventor strives via associated experience and research to present the instant disclosure, which can effectively improve the limitation described above.

### SUMMARY OF THE INVENTION

The main purpose of the instant disclosure is to provide a method for a terminal unit to retain a solder material which solves the problems of conventional welding such as solder materials susceptible to fall off and position shifting on the terminal unit.

In order to achieve the aforementioned objectives, a plurality of embodiments of the present disclosure provides a method for retaining solder material onto a terminal unit. Initially, a generally elongated terminal unit having a fixing portion formed toward one end thereof is provided. Next, a solder material is provided and processed to form a pre-processed sleeve structure adapted to envelop a corresponding end of the terminal unit, thus forming a gap between the pre-processed sleeve structure and the terminal unit. Successively, applying an external force to the pre-processed sleeve structure to envelop the terminal unit, thus causing local deformation thereof, thereby causing the solder material to retain onto the fixing portion of the terminal unit.

To achieve the aforementioned objectives, the instant disclosure also provides a solder material and an electrical connector terminal unit combination structure, comprising: a generally elongated terminal unit having a fixing portion formed toward one end thereof and a solder material processed to form a pre-processed sleeve structure adapted to sleevingly coupled to the fixing portion of the terminal unit.

In summary, the instant disclosure not only efficiently stabilizes the connectivity between the terminal unit and the solder material, but also significantly reduces the chances of solder material from falling off of the terminal unit. Therefore, highly reliable retaining effect can be attained.

In order to further the understanding of the method for sleeve retaining a solder material onto a terminal unit thereof, the following embodiments are provided along with illustrations to facilitate the disclosure. However, the detailed description and drawings are merely illustrative of the disclosure, rather than limiting the scope being defined by the appended claims and equivalents thereof.

### BRIEF DESCRIPTION OF THE DRAWINGS

FIG. 1A shows the perspective exploded view of the “cylindrical sleeve” solder material and the terminal unit according to the first embodiment of the instant disclosure;

FIG. 1B shows the perspective assembled view of the “cylindrical sleeve” solder material and the terminal unit according to the first embodiment of the instant disclosure;

FIG. 2A shows the perspective exploded view of the “grooved cylindrical sleeve” solder material and the terminal unit according to the second embodiment of the instant disclosure;

FIG. 2B shows the perspective assembled view of the “ grooved cylindrical sleeve” solder material and the terminal unit according to the second embodiment of the instant disclosure;

FIG. 2C shows the perspective assembled view of the “grooved cylindrical sleeve” solder material and the terminal unit according to the second embodiment of the instant disclosure;

FIG. 2D shows the cross-sectional view of the “grooved cylindrical sleeve” solder material and the terminal unit according to the second embodiment of the instant disclosure;

FIG. 3A shows the perspective exploded view of the “bullet-type sleeve” solder material and the terminal unit according to the third embodiment of the instant disclosure;

FIG. 3B shows the perspective assembled view of the “bullet-type sleeve” solder material and the terminal unit according to the third embodiment of the instant disclosure;

FIG. 4A shows the perspective exploded view of the “spiral-type sleeve” solder material and the terminal unit according to the fourth embodiment of the instant disclosure;

FIG. 4B shows the perspective assembled view of the “spiral-type sleeve” solder material and the terminal unit according to the fourth embodiment of the instant disclosure;

FIG. 5 shows the flow chart of the method for sleeve retaining the solder material onto the terminal unit.

### DETAILED DESCRIPTION OF THE PREFERRED EMBODIMENTS

The following illustrations and detailed descriptions are exemplary for the purpose of further explaining the scope of the present disclosure. Other objectives and advantages related to the present disclosure will be illustrated in the subsequent descriptions and appended drawings.

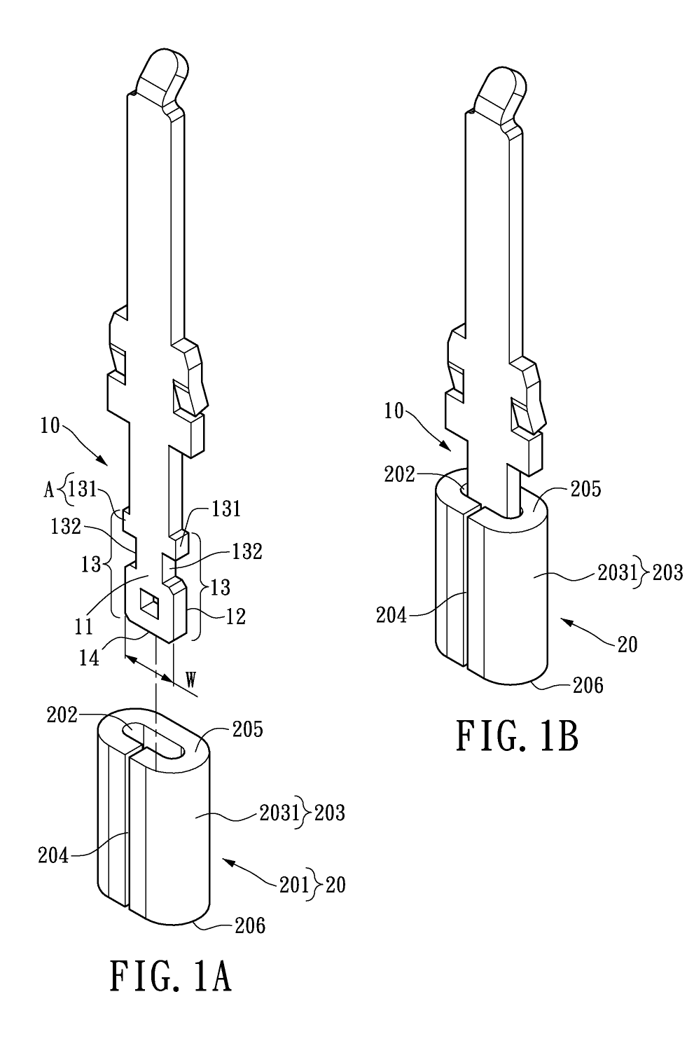

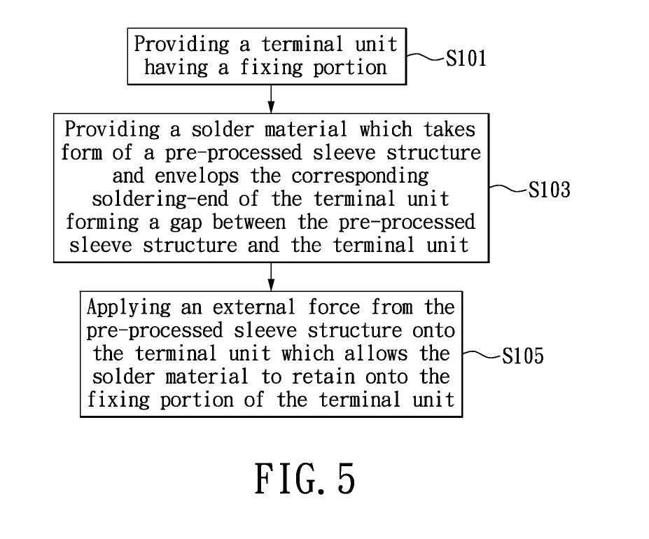

Referring to FIG. 1A in conjunction with FIG. 1B and FIG. 5, the method for sleeve retaining of a solder material onto a terminal unit thereof comprises of the following steps: providing a terminal unit 10 having a fixing portion A. Next, providing a solder material 20 which takes form of a pre-processed sleeve structure 201 and envelops the corresponding soldering-end of the terminal unit 10 forming a gap 202 between the pre-processed sleeve structure 201 and the terminal unit 10. Successively, applying an external force F (not shown in FIGS. 1A, 1B, and 5) from the pre-processed sleeve structure 201 onto the terminal unit 10 which allows the solder material 20 to retain onto the fixing portion A of the terminal unit 10.

Continually referring to FIG. 1A in conjunction with FIG. 1B, a first embodiment for the sleeve retaining of a solder material onto a terminal unit thereof includes a terminal unit 10 and a solder material 20.

One end of the terminal unit 10 has a hollowed square structure (not labeled) known as a retaining slot 15 which connects the front face 11 to the back face 12. Said retaining slot 15 is also a fixing portion A which is designed on the terminal unit 10 for retaining onto the solder material 20.

The solder material 20 is not limited to the form of a strip, a bit and a sheet. Once the pre-processed form as mentioned above is defined, said solder material 20 becomes a pre-processed sleeve structure 201. In the first instant embodiment, the form is a solder bit. Before sleeve retains on the terminal unit 10, the pre-processed sleeve structure 201 is processed into a processed sleeve 203. In details, the pre-processed sleeve structure 201 is disposed in a pre-defined distance (preferably close distance) away from the terminal unit 10 in a corresponding position with a fixing portion A. The fixing portion A is a feature of the terminal unit 10 which has the characteristics of fixating another feature of the solder material 20 onto the terminal unit 10. Then the pre-processed sleeve structure 201 is pressed into the shape of the processed sleeve 203 onto the terminal unit 10. In particular, the processed sleeve 203 in the first instant embodiment has a cylindrical shape known as a cylindrical sleeve 2031.

After the pre-processed sleeve structure 201 is processed into the processed sleeve 203 and envelops the terminal unit 10, a plurality of features is generated which depends on the form in which the pre-processed sleeve structure 201 takes. In particular, FIG. 1A in conjunction with FIG. 1B shows the first instant embodiments of the instant disclosure illustrating said features comprises a solder top 205, a solder bottom 206, and a slit 204 which is formed by the two ends of the processed sleeve 203 being pressed towards each other. The solder top 205 is essentially the top surface while the solder bottom is essentially the bottom surface of the processed sleeve 203 where the surface area of both surfaces highly depends on the shape which the processed sleeve 203 takes.

When the processed sleeve 203 envelops the terminal unit 10, the solder bottom 206 is disposed flushed against the bottom face 14. However, the solder bottom 206 may also be circumventing while being a step-up from the bottom face 14.

The terminal unit 10 also includes a plurality of surfaces as follow: a front face 11, a back face 12, two side faces 13, and a bottom face 14. The fixing portion A is a protrusion 131 in the first instant embodiments of the instant disclosure. Said protrusion 131 is disposed on each of the two side faces 13 to facilitate retaining of the solder material 20.

The terminal unit 10 also has a width W which is defined by the distance between the two side faces 13. Said width W is also the width of the protrusion 131 where width W is defined by user. In addition to the protrusion 131, a recess 132 is also disposed along each side face 13.

After the solder material 20 envelops the terminal unit 10, an external force F (not illustrated in FIGS. 1A and 1B) may apply to the exterior surface of the processed sleeve 203 to improve connectivity between the solder material 20, the protrusion 131 and the recess 132. Thus, providing better sleeve retaining effect.

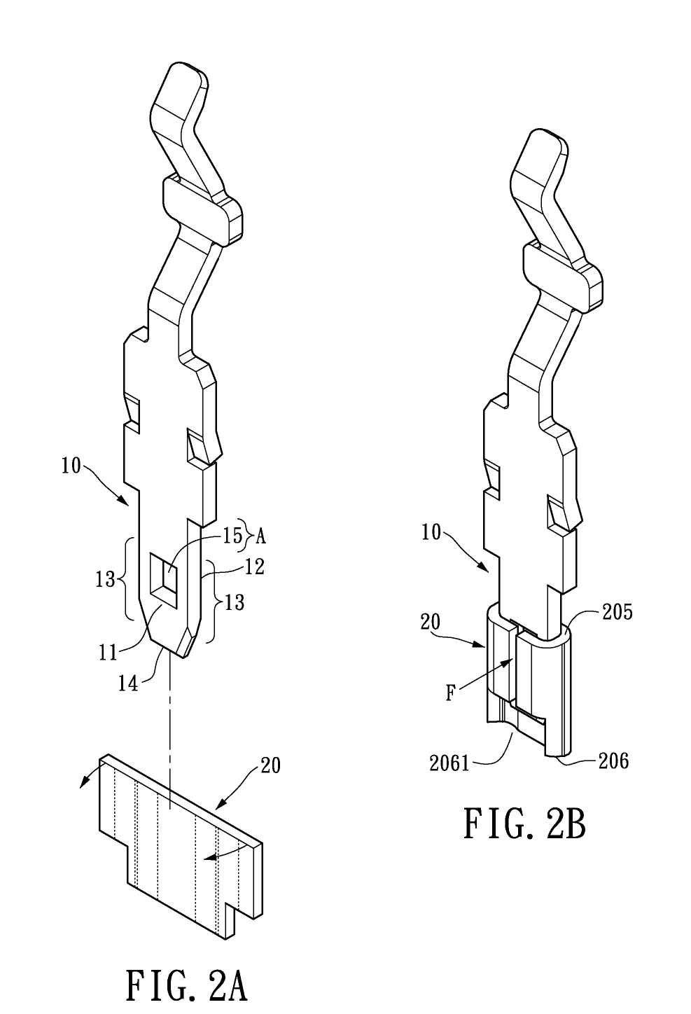

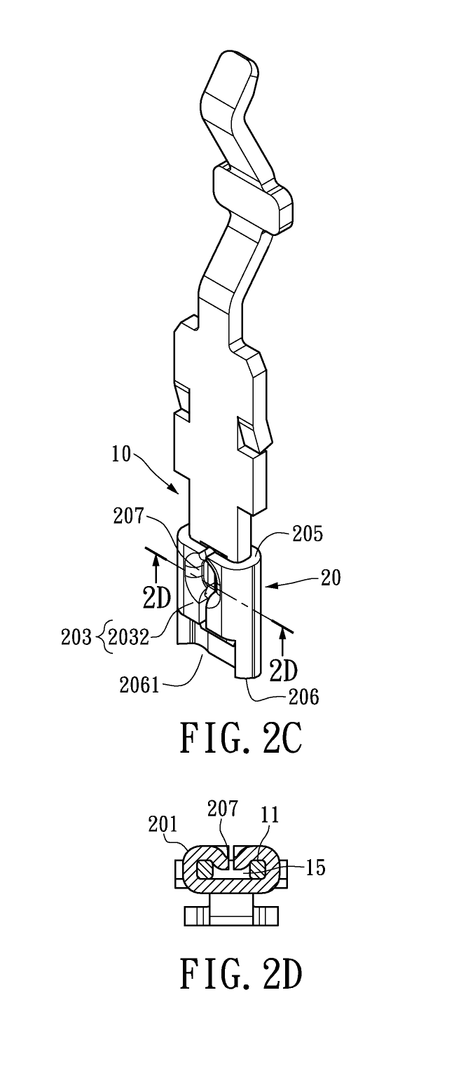

According to FIG. 2A in conjunction with FIGS. 2B, 2C, and 2D, the second instant embodiment differs from the previous embodiment in the designated fixing portion A. In the second instant embodiment, the designated fixing portion is a retaining slot 15. Specifically, after the processed sleeve 203 envelops the terminal unit 10, an external force F is applied onto portions of the two ends of the enveloping processed sleeve 203 towards the direction of the retaining slot 15. Said portions consequently deforms and displaces into the retaining slot 15, and forms a groove 207. As a result of the unique shape of the second embodiment known as a grooved cylindrical sleeve 2032, the solder material 20 retains onto the terminal unit 10. In addition, prior to forming the pre-processed sleeve structure 201, a cut may be applied to the solder bottom 206 to form a solder notch 2061 to remove soldering materials from the solder material 20. Subsequently, as the external force F is applied upon the slit 204 to form a groove 27, the solder bottom 206 is less prone to displace outward away from the terminal unit 10. Consequently, issues with soldering process and positioning of soldering points' may be prevented.

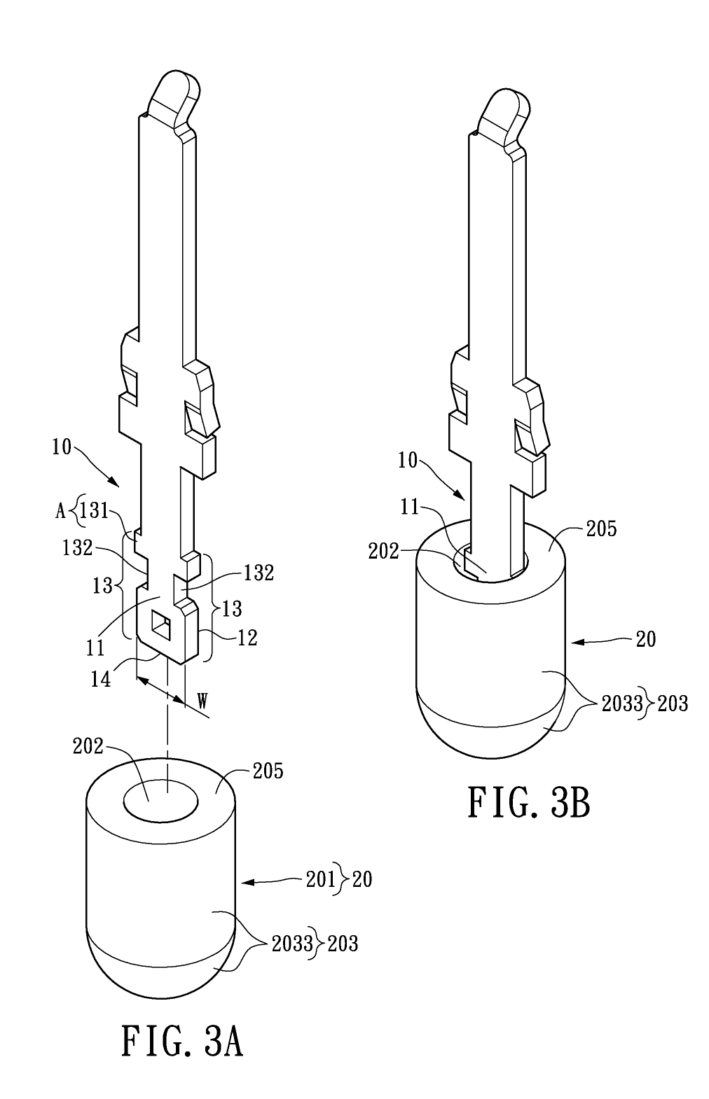

According to the FIG. 3A in conjunction with FIG. 3B, the third instant embodiment varies from the previous instant embodiments wherein the processed sleeve 203 takes form of a bullet know as a bullet-type sleeve 2033. Similar to the previous instant embodiments, the bullet-type sleeve 2033 has a solder top 205 and a solder bottom 206. However, in the third instant embodiment, the solder bottom 206 is dome-shaped. Similar to the first instant embodiment, the fixing portion A in the third instant embodiment is the protrusions 131 which are disposed along the sides of the terminal unit 10 for sleeve retaining of the solder material 20 through the abutment of the protrusions 131 and the processed sleeve 203 with an external force F (not illustrated in FIGS. 3A, and 3B).

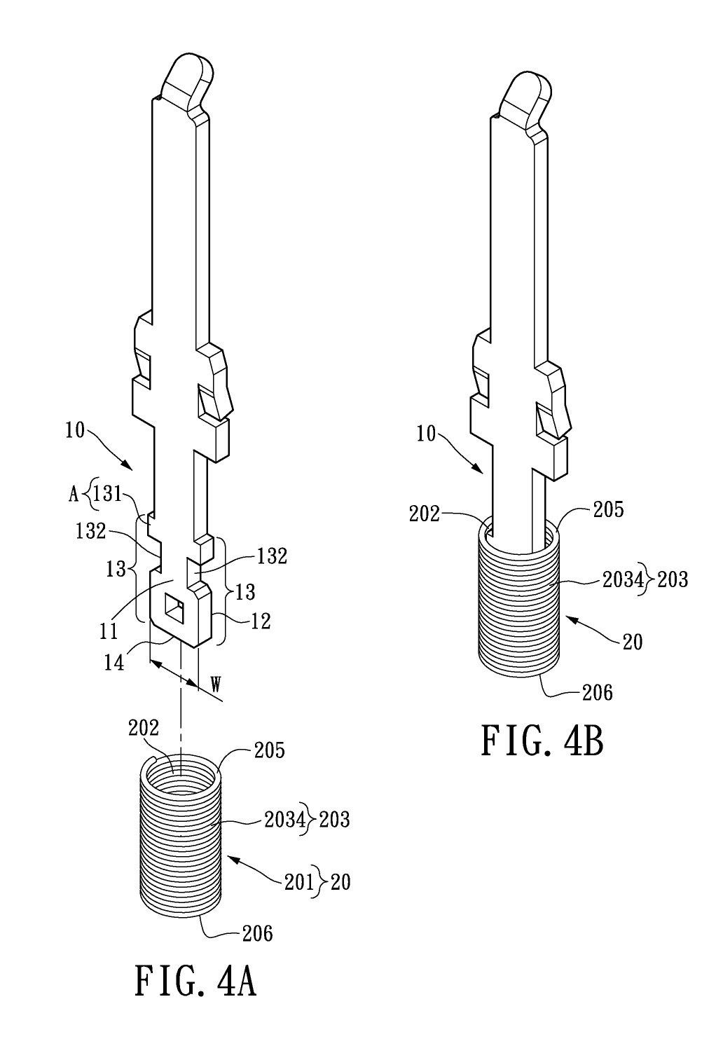

According to the FIG. 4A in conjunction with FIG. 4B, the fourth instant embodiment varies from the previous instant embodiments where the solder material 20 is formed by rolling and bending the solder strips into a spiral-type sleeve 2034. Similar to the first instant embodiment, the processed sleeve 203 also has the solder top 205 and the solder bottom 206 which is but not limited to be disposed flushed against the bottom face 14. For instance: the solder bottom 206 may also be circumventing and a step-up from the bottom face 14. Once again, similar to the first instant embodiment, the fixing portion A in the fourth instant embodiment is the protrusions 131 which are disposed along the sides of the terminal unit 10 for sleeve retaining of the solder material 20 through the abutment of the protrusions 131 and the processed sleeve 203 with an external force F (not illustrated in FIGS. 4A, and 4B).

Preferably, the pre-processed sleeve structure 201 takes the form of a processed sleeve 203 which envelops the terminal unit 10 in one of the following forms: a cylindrical sleeve 2031 (FIG. 1A), a grooved cylindrical sleeve 2032 (FIG. 2C), a bullet-type sleeve 2033 (FIG. 3A), and a spiral-type sleeve 2034 (FIG. 4A). The cylindrical sleeve 2031 and the grooved cylindrical sleeve 2032 are preferably formed but are not limited to be formed from a solder sheet, while the bullet-type sleeve 2033 and the spiral-type sleeve 2034 are formed but not limited to be formed from a bit of solder and a strip of solder, respectively. For instance, to form the spiral-type sleeve 2034 as mentioned above, a strip of solder is rolled and bent through suitable tools and equipment.

Moreover, the slit 204 only pertains to the first and second instant embodiments according to the instant disclosure. In the third instant embodiment of bullet-type sleeve 2033, only the solder top 205 is formed. Finally, in the fourth instant embodiments of spiral-type sleeve 2034, only the solder top 205 and the solder bottom 206 are formed.

Preferably, the fixing portion A is the protrusions 131. Said protrusions 131 are disposed on the two side faces 13 of the terminal unit 10 to facilitate retaining of the processed sleeve 30 by the application of the applied force F. As a consequence, enabling the solder material 20 to retain onto the fixing portion A. In the other example, the fixing portion A is the retaining slot 15. Specifically, an external force F is applied onto portions of the two ends of the enveloping processed sleeve 203 towards the direction of the retaining slot 15. Said portions consequently deforms and displaces into the retaining slot 15, and forms a groove 207 which retains onto the terminal unit 10. In addition to the protrusion 131, the recess 132 which is disposed on the two side faces 13 may also support retaining the solder material 20.

In further details, the external force F describes in FIGS. 2A, 2B, 2C, and 2D of the instant disclosure retains the solder material 20 onto the retaining slot 15 thus further enhance the connection between the solder material 20 and the terminal unit 10.

In summary, the method of retaining the soldering material structure 20 onto the terminal unit 10 according to the instant disclosure allows soldering materials to be effectively deposited onto the terminal units. The instant disclosure is space saving, does not require additional positioning adjustments during welding, and effectively simplifies welding. Thus, ensures welding efficiency.

The descriptions illustrated supra set forth simply the preferred embodiments of the present disclosure; however, the characteristics of the present disclosure are by no means restricted thereto. All changes, alternations, or modifications conveniently considered by those skilled in the art are deemed to be encompassed within the scope of the present disclosure delineated by the following claims.

What is claimed is:

1. A method for sleeve retaining a solder material onto a terminal unit comprising:
a) providing a generally elongated terminal unit having a fixing portion formed toward one end thereof;
b) providing a solder material processed to form a pre-processed sleeve structure adapted to envelop a corresponding end of the terminal unit to form a gap between the pre-processed sleeve structure and the terminal unit;
c) applying an external force to the pre-processed sleeve structure enveloping the terminal unit to cause local deformation thereof, and thereby causing the solder material to retain onto the fixing portion of the terminal unit.

2. The method according to claim 1, wherein the terminal unit includes a front face, a back face, two opposite side faces, and a bottom face; the fixing portion is a retaining slot defined on the side face of the terminal unit in connection with the front face and the back face; the external force is exerted onto a pre-processed sleeve structure generating a groove thereon around the retaining slot, and thereby providing retaining effect.

3. The method according to claim 1, wherein the fixing portion is a protrusion disposed on the two side faces; the external force is exerted on the pre-processed sleeve structure causing local deformation thereon around the protrusion, and thereby providing retaining effect

4. A solder material and an electrical connector terminal unit combination structure, comprising:
a generally elongated terminal unit having a fixing portion formed toward one end thereof; and
a solder material processed to form a pre-processed sleeve structure adapted to sleevingly couple to the fixing portion of the terminal unit.

5. The structure according to claim 4, wherein the terminal unit comprises a front face, a back face, two side faces, and a bottom face; the fixing portion is a retaining slot connecting the front face to the back face; the external force is exerted onto a pre-processed sleeve structure to form a groove within the retaining slot thereby providing retaining effect.

6. The structure according to claim 5, wherein the pre-processed sleeve structure is processed into a processed sleeve taking the shape of a grooved cylindrical sleeve; the grooved cylindrical sleeve possesses a solder bottom arranged flushed against the bottom face or a step-up from the bottom face.

7. The structure according to claim 4, wherein the terminal unit includes the front face, the back face, two side faces, and the bottom face; the fixing portion is the protrusion disposed on the two side faces thereby the solder material is retained onto the protrusion.

8. The structure according to claim 7, wherein the pre-processed sleeve structure is processed into the processed sleeve taking another shape of a cylindrical sleeve; the cylindrical sleeve includes a solder top, a slit, and a solder bottom arranged flushed against the bottom face or a step-up from the bottom face.

9. The structure according to claim 7, wherein the pre-processed sleeve structure is processed into the processed sleeve taking another shape of a bullet-type sleeve; the bullet-type sleeve includes a solder top, and a dome-shaped solder bottom.

10. The structure according to claim 7, wherein the pre-processed sleeve structure is processed into the processed sleeve taking another shape of a spiral-type sleeve; the spiral-type sleeve includes a solder top, a slit, and a solder bottom arranged flushed against the bottom face or a step-up from the bottom face.
